(19) United States
(12) Patent Application Publication
(10) Pub. No.: US 2026/0065059 A1
(43) Pub. Date: Mar. 5, 2026

(54) CLASSIFICATION APPARATUS, CLASSIFICATION METHOD, AND CLASSIFICATION PROGRAM

(71) Applicant: JVCKENWOOD Corporation, Yokohama-shi (JP)

(72) Inventor: Yincheng YANG, Yokohama-shi (JP)

(21) Appl. No.: 19/314,790

(22) Filed: Aug. 29, 2025

(30) Foreign Application Priority Data
Sep. 2, 2024 (JP) 2024-150668

(51) Int. Cl. G06N 3/082; G06N 3/09

(52) U.S. Cl. CPC G06N 3/082; G06N 3/09

(57) ABSTRACT

A classification apparatus includes: a feature quantity output unit that outputs a feature quantity of input data; and a classification unit that retains, as a classification weight, a feature quantity obtained by averaging, per each class, the feature quantity output by the feature quantity output unit in response to a base class dataset and a novel class dataset with a smaller number of data items than the base class dataset and that outputs a result of classification of the input data by using the feature quantity of the input data and the classification weight.

### BACKGROUND

### 1. Technical Field

The present disclosure relates to classification technology.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-learn CNN parameters in response to the entirety of the dataset. In CNN, the precision estimation for old tasks will be decreased as new tasks are learned. Thus, catastrophic forgetting cannot be avoided in CNN. Namely, the result of learning old tasks is forgotten as new tasks are being learned in continual learning.

A more efficient and practical method proposed is incremental learning or continual learning in which the knowledge already acquired is reused, and new tasks are learned without forgetting the knowledge of past tasks. Continual learning is a learning method that improves a current trained model to learn new tasks and new data as they occur, instead of training the model from scratch. In deep learning, there is a phenomenon called catastrophic forgetting in which the knowledge acquired in the past is considerably lost, and the ability for tasks is considerably reduced. This presents a problem in continual learning in particular. Continual learning in a classification task is a scheme that allows migration from a state in which classification into classes learned in the past (base classes) is enabled to a state in which new classes (novel classes) are learned to enable classification into the novel classes. The biggest challenge is to avoid catastrophic forgetting and maintain the performance for base class classification while at the same time acquiring the performance for novel class classification.

NISPA (Neuro-Inspired Stability-Plasticity Adaptation is proposed as one of schemes for continual learning configured to avoid catastrophic forgetting (see, for example, Non-Patent Literature 1). NISPA is a scheme of emulating the memory mechanism of the human brain and removing or adding a path across nodes between adjacent layers in a neural network during continual learning. NISPA retains a path across nodes proven to have a high activation value in base class learning (stable node) and randomly disconnects a path across other nodes. With this, NISPA can preferentially maintain, among the memory paths obtained by base class learning, those paths across stable nodes that are highly likely to be used for classification into other classes in common.

[Non-patent Literature 1] Mustafa Burak Gurbuz & Constantine Dovrolis (2022). NISPA: Neuro-Inspired Stability-Plasticity Adaptation for Continual Learning in Sparse Networks. International Conference on Machine Learning 2022. arXiv: 2206.09117. [Non-patent Literature 2] Qianru Sun, Yaoyao Liu, Tat-Seng Chua & Bernt Schiele (2019). Meta-Transfer Learning for Few-Shot Learning. Computer Vision and Pattern Recognition 2019. arXiv: 1812.02391. [Non-patent Literature 3] Geoffrey Hinton, Oriol Vinyals & Jeff Dean (2015). Distilling the Knowledge in a Neural Network. NIPS 2014 Deep Learning Workshop. arXiv: 1503.02531.

Learning like NISPA, wherein a path across nodes between adjacent layers in a neural network is removed or added, assumes the use of a large-scale dataset called big data. In the case that continual learning is performed by using a dataset containing a small number of samples due to circumstances such as a small number of sample data items, therefore, there is a possibility that learning cannot be performed properly.

Duplication of sample data, etc. can be conceivable as a scheme for increasing sample data. However, such a scheme is known to fall into overfitting with good local performance but poor generalization performance, and it has been difficult to maintain the accuracy of classification.

### SUMMARY

A classification apparatus according to an embodiment of the present disclosure includes: a feature quantity output unit that outputs a feature quantity of input data; and a classification unit that retains, as a classification weight, a feature quantity obtained by averaging, per each class, the feature quantity output by the feature quantity output unit in response to a base class dataset and a novel class dataset with a smaller number of data items than the base class dataset and that outputs a result of classification of the input data by using the feature quantity of the input data and the classification weight. The feature quantity output unit is generated by subjecting a neural network to training that uses the base class dataset, the training including removing or adding a path across nodes between adjacent layers in the neural network and then training the neural network by distillation by using the novel class dataset with reference to a further feature quantity output unit as a supervisor model.

Another embodiment of the present disclosure relates to a classification method. The method includes: outputting a feature quantity of input data; and retaining, as a classification weight, a feature quantity obtained by averaging, per each class, the feature quantity output by the outputting in response to a base class dataset and a novel class dataset with a smaller number of data items than the base class dataset and outputting a result of classification of the input data by using the feature quantity of the input data and the classification weight. A feature quantity output unit executing the outputting is generated by being subject to training using the base class dataset, the training including removing or adding a path across nodes between adjacent layers in a neural network and then being trained by distillation by using the novel class dataset with reference to a further feature quantity output unit as a supervisor model.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a functional block diagram schematically showing an outline configuration of a classification apparatus according to the embodiment;

FIG. 2 is a flowchart showing an example of the flow of the process for generating the feature quantity output unit and the classification unit shown in FIG. 1 executed by the learning apparatus;

FIG. 3 shows an example of the configuration related to the process of the flowchart shown in FIG. 2;

FIG. 4 shows an example of creating data related to the process of the flowchart shown in FIG. 2;

FIG. 5 shows an example of the configuration of a classification apparatus including a second feature quantity output unit and a second classification unit;

FIG. 6 shows a configuration related to inner learning executed by the learning apparatus;

FIG. 7 shows a configuration related to outer learning executed by the learning apparatus;

FIG. 8 shows an example of the configuration related to the process of the flowchart shown in FIG. 2;

FIG. 9 shows an example of the configuration related to the process of the flowchart shown in FIG. 2;

FIG. 10 shows an example of the configuration related to the process of the flowchart shown in FIG. 2;

FIG. 11 shows an example of the configuration related to the process of the flowchart shown in FIG. 2;

FIG. 12 shows an example of the configuration of a classification apparatus including the fourth feature quantity output unit and the fifth classification unit;

FIG. 13 shows a variation of the configuration related to the process of the flowchart shown in FIG. 2; and

FIG. 14 shows a variation of the configuration related to the process of the flowchart shown in FIG. 2.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration.

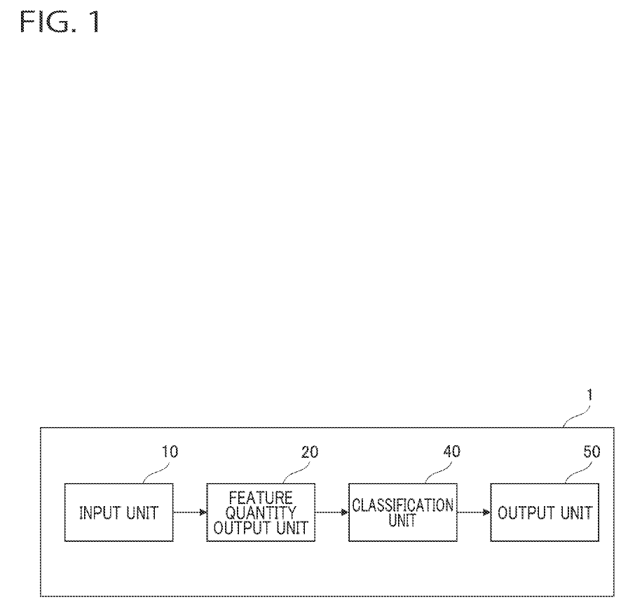

FIG. 1 is a functional block diagram schematically showing an outline configuration of a classification apparatus 1 according to the embodiment. As shown in FIG. 1, the classification apparatus 1 includes an input unit 10, a feature quantity output unit 20, a classification unit 40, and an output unit 50.

The input unit 10 receives input data subject to classification by the classification apparatus 1. The input data is, for example, data for an image in which an object is captured, and the captured object is an animal, a vehicle, a person, etc.

The feature quantity output unit 20 outputs the feature quantity of the input data received by the input unit 10. The feature quantity output unit 20 is a neural network model that has been trained by continual learning. The feature quantity output unit 20 performs meta learning by using a base class dataset. Further, the feature quantity output unit 20 is generated by subjecting a neural network to training that uses the base class dataset, the training including removing or adding a path across nodes between adjacent layers in the neural network and then training the neural network by distillation by using a novel class dataset with reference to a further feature extraction unit as a supervisor model. For example, the scheme described in Non-Patent Literature 3 can be used as the distillation scheme. The feature quantity output unit 20 may complete continual learning or may be updatable by further performing continual learning. The number of layers in the neural network model included in the feature quantity output unit 20 is seven by way of one example but is not particularly limited as long as there are four layers or more. Details of continual learning in the feature quantity output unit 20 will be described later.

The classification unit 40 classifies the input data received by the input unit 10. The classification unit 40 retains the classification weight of each class. The classification unit 40 receives the feature quantity output by the feature quantity output unit 20 as an input and classifies the input data based on the feature quantity and the classification weight. The classification weight retained by the classification unit 40 is a feature quantity (centroid) obtained by averaging, per class, the feature quantity output by the feature quantity output unit 20 in response to the base class dataset and the novel class dataset as inputs. The number of data items in the novel class dataset is smaller than the number of data items in the base class dataset. The classification unit 40 compares the feature quantity with the classification weight and defines the class with the classification weight closest to the feature quantity to be the classification result.

The output unit 50 outputs the classification result by the classification unit 40. In other words, the output unit 50 outputs information indicating which class the input data is classified into. The output unit 50 is, for example, a display apparatus such as a display or an audio output apparatus such as a speaker that outputs sound.

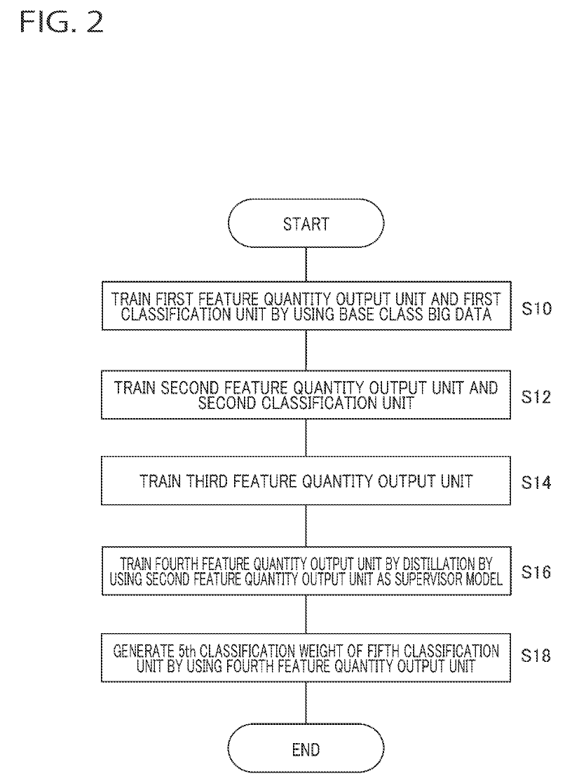

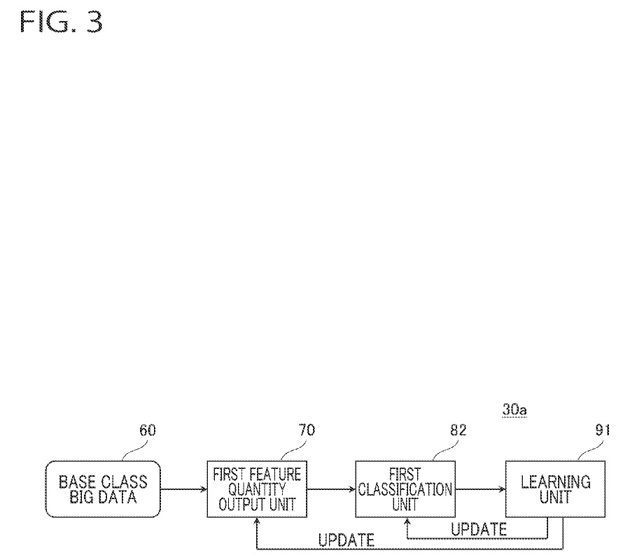

FIG. 2 is a flowchart showing an example of the flow of the process for generating the feature quantity output unit 20 and the classification unit 40 executed by the learning apparatus shown in FIG. 3, etc. FIG. 3 shows an example of the configuration related to the process of step S10 of the flowchart shown in FIG. 2.

As shown in FIGS. 2 and 3, a learning apparatus 30a pre-trains the first feature quantity output unit 70 and a first classification unit 82 by using base class big data 60 (S10). The pre-training in the process of step S10 may be general machine learning using big data.

As shown in FIG. 3, the learning apparatus 30a includes a first feature quantity output unit 70, a first classification unit 82, and a learning unit 91. The first feature quantity output unit 70 is a neural network model that outputs a first feature quantity that is the feature quantity of the input data and is used to generate the feature quantity output unit 20 and the classification unit 40. This applies equally to a second feature quantity output unit 76, a third feature quantity output unit 78, and a fourth feature quantity output unit 80, which will be described later. In other words, the nth (n is a natural number) feature quantity output unit outputs the nth feature quantity, which is the feature quantity of the input data, regardless of the content of the input data. The first classification unit 82 is a classification unit that retains the 1st classification weight that is a classification weight and outputs a classification result by using the first feature quantity and the 1st classification weight. The first classification unit 82 is used to generate the feature quantity output unit 20 and the classification unit 40. This applies equally to a second classification unit 84, a third classification unit 86, and a fourth classification unit 88, which will be described later, wherein each retains a different classification weight. In other words, the nth classification unit retains the nth classification weight.

The base class big data 60 is input to the first feature quantity output unit 70. The first feature quantity output unit 70 extracts and outputs the first feature quantity of each data included in the input base class big data 60. The first classification unit 82 classifies the input data into a class based on the first feature quantity input from the first feature quantity output unit 70 and the 1st classification weight. The learning unit 91 calculates a loss from the correct label and the classification and updates the parameter of the first feature quantity output unit 70 and the 1st classification weight of the first classification unit 82 so as to minimize the loss. The base class big data 60 is, for example, data for 60 classes, and each class includes 100 image data items.

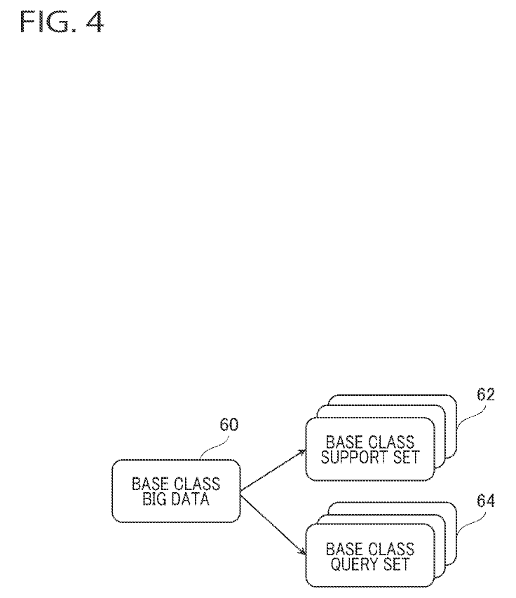

FIG. 4 shows an example of creating data related to the process of the flowchart shown in FIG. 2. As shown in FIG. 4, data obtained by dividing the base class big data 60 into a plurality of support sets 62 and query sets 64 is prepared before proceeding to the process of step S12 of FIG. 2. Each of the support set 62 and the query set 64 is used in meta learning in few-shot continual learning described later. The support set 62 is used in inner learning in meta learning. The query set 64 is used in outer learning in meta learning. For example, 100 image data items are selected from the big data 60, of which 25 image data items constitute the support set 62, and 75 image data items constitute the query set 64 to form one group. One group contains images in 5 classes, and both the support set 62 and the query set 64 have data for the same classes. In other words, the support set 62 includes 5 image data items per class, and the query set 64 includes 15 image data items per class.

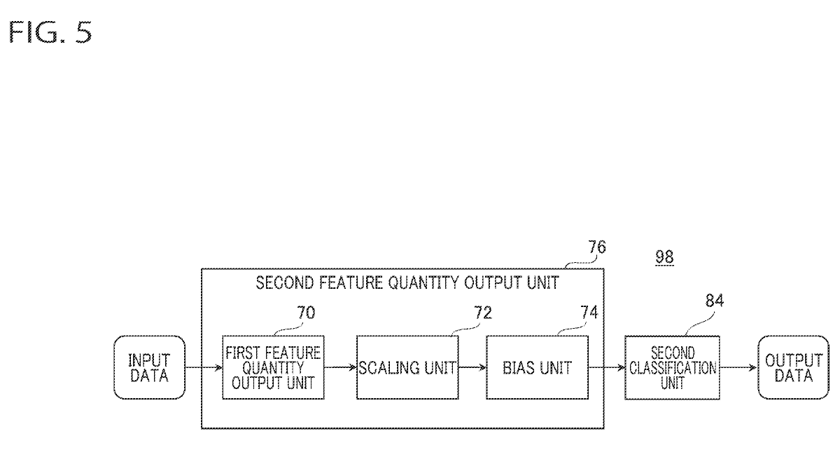

FIG. 5 shows an example of the configuration of a classification apparatus 98 including a second feature quantity output unit 76 and a second classification unit 84 for illustration of the second feature quantity output unit 76 and the second classification unit 84 that are subjected to meta learning in the process of step S12 described later. As shown in FIG. 5, the second feature quantity output unit 76 includes a first feature quantity output unit 70, a scaling unit 72, and a bias unit 74. The scaling unit 72 outputs a multiplication result obtained by multiplying a predetermined multiplication value by the first feature quantity output by the first feature quantity output unit 70 in response to the input data. The bias unit 74 outputs an addition result obtained by adding a predetermined addition value to the multiplication result from the scaling unit 72. The second classification unit 84 retains a 2nd classification weight, which is a weight for classification into each class. The 2nd classification weight is a condensed classification weight. The condensed classification weight may be the same as that described in Non-Patent Literature 3. For example, five condensed classification weights may be available, and classification into all classes is enabled by using the five condensed classification weights. The second classification unit 84 receives the addition result from the bias unit 74 as an input and outputs a classification result from the addition result and the 2nd classification weight. The initial value of the multiplication value of the scaling unit 72 and the initial value of the addition value of the bias unit 74 may each be arbitrary values, but it is preferable that they are values that do not change the value output by the first feature quantity output unit 70 significantly.

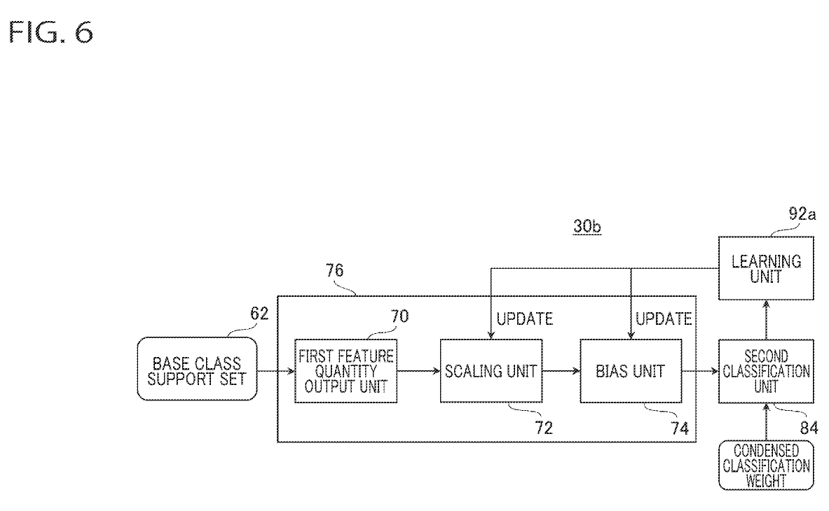

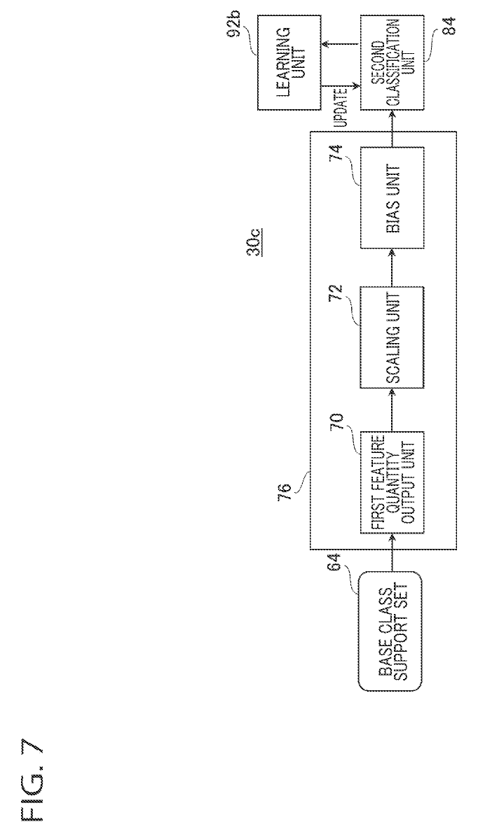

As shown in FIG. 2, the learning apparatuses 30b, 30c (see FIGS. 6 and 7) train the second feature quantity output unit 76 and the second classification unit 84 (S12). The process of step S12 is meta learning. Meta learning includes inner learning and outer learning.

FIG. 6 shows a configuration related to inner learning executed by the learning apparatus 30b. In inner learning, the support set 62 for the base class is used to update the multiplication value used by the scaling unit 72 and the addition value used by the bias unit 74. As shown in FIG. 6, the first feature quantity output unit 70 outputs the first feature quantity in response to the support set 62 for the base class as an input. The scaling unit 72 outputs a multiplication result obtained by multiplying the multiplication value by the first feature quantity. The bias unit 74 outputs an addition result obtained by adding the addition value to the multiplication result. The second classification unit 84 outputs a classification result from the addition result and the 2nd classification weight in response to the addition result as an input. The learning unit 92a calculates a loss in response to the classification result as an input. The learning unit 92a updates the multiplication value and the addition value based on the loss so as to minimize the loss, for example. In inner learning, the 2nd classification weight of the second classification unit 84 is not updated. The initial value of the 2nd classification weight may be random.

FIG. 7 shows a configuration related to outer learning executed by the learning apparatus 30c. In outer learning, the 2nd classification weight used by the second classification unit 84 is updated by using the query set 64 for the base class after the multiplication value and the addition value are determined by inner learning. As shown in FIG. 7, the first feature quantity output unit 70 outputs the first feature quantity in response to the query set 64 for the base class as an input. The scaling unit 72 outputs a multiplication result obtained by multiplying the multiplication value by the first feature quantity. The bias unit 74 outputs an addition result obtained by adding the addition value to the multiplication result. The second classification unit 84 outputs a classification result from the addition result and the 2nd classification weight in response to the addition result as an input. The learning unit 92b calculates a loss in response to the classification result as an input. The learning unit 92b updates the 2nd classification weight based on the loss so as to minimize the loss, for example. In outer learning, the multiplication value and the addition value are not updated.

The learning apparatuses 30b and 30c alternately execute inner learning and outer learning described above one epoch at a time to determine the multiplication value, the addition value, and the 2nd classification weight.

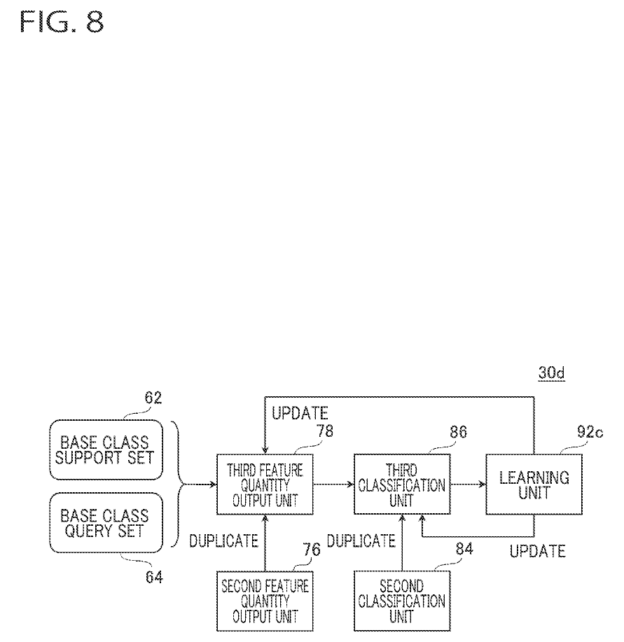

FIG. 8 shows an example of the configuration related to the process of step S14 of the flowchart shown in FIG. 2. As shown in FIGS. 2 and 8, the learning apparatus 30d trains the third feature quantity output unit 78 (S14). The path in the third feature quantity output unit 78 is a path across nodes between adjacent layers in a neural network, and the learning apparatus 30d performs training, which includes removing or adding the path. The third feature quantity output unit 78 outputs the third feature quantity in response to the support set 62 and the query set 64 for the base class as inputs. A duplicate of the second feature quantity output unit 76 trained in step S12 may be used as the third feature quantity output unit 78. In other words, the third feature quantity output unit 78 includes a neural network, a scaling unit, and a bias unit (all of which are omitted from the illustration). The neural network path included in the third feature quantity output unit 78, the activation of each node, and each initial value of the weight of a path across nodes between adjacent layers may be the same as those of the second feature quantity output unit 76. Similarly, the initial values of the multiplication value used by the scaling unit included in the third feature quantity output unit 78 and of the addition value used by the bias unit in the third feature quantity output unit 78 may be the multiplication value used by the scaling unit 72 included in the second feature quantity output unit 76 and the addition value used by the bias unit 74 included in the second feature quantity output unit 76, respectively. It will be noted that the activation of a given node is determined based on the activation of the parent node connected in a layer immediately preceding the given node, i.e., a layer toward the input layer, and on the weight of connection with that parent node.

The third classification unit 86 retains a 3rd classification weight having, as an initial value, the 2nd classification weight of the second classification unit 84 subjected to outer learning. In other words, the 3rd classification weight is a condensed classification weight. The third classification unit 86 outputs a classification result from the third feature quantity and the 3rd classification weight in response to the third feature quantity from the third feature quantity output unit 78 as an input. Based on the classification result from the third classification unit 86, the learning unit 92c updates the path in the third feature quantity output unit 78 and the 3rd classification weight of the third classification unit 86. The learning apparatus 30 executes the process of step S14 one epoch at a time. The scheme for updating the path in the third feature quantity output unit 78 executed by the learning unit 92c is not particularly limited but may be the scheme based on NISPA of Non-Patent Literature 1.

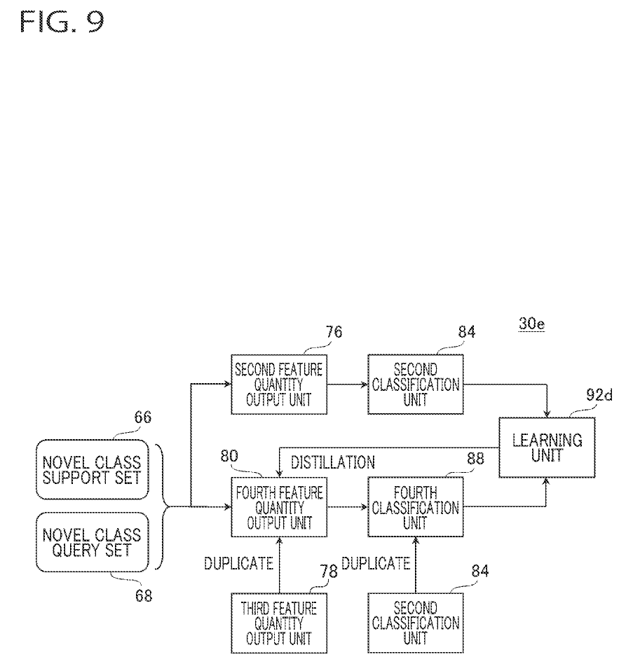

FIG. 9 shows an example of the configuration related to the process of step S16 of the flowchart shown in FIG. 2. As shown in FIGS. 2 and 9, the learning apparatus 30e trains the fourth feature quantity output unit 80 by distillation by using the second feature quantity output unit 76 as a supervisor model (S16). The second feature quantity output unit 76 outputs the fourth feature quantity in response to a support set 66 and a query set 68 for the novel class as inputs. It will be noted that the number of data items in the novel class dataset is smaller than the number of data items in the base class dataset. The second classification unit 84 outputs a classification result from the second feature quantity and the 2nd classification weight in response to the second feature quantity from the second feature quantity output unit 76 as an input.

The fourth feature quantity output unit 80 outputs a feature quantity in response to the support set 66 and the query set 68 for the novel class as inputs. A duplicate of the third feature quantity output unit 78 may be used as the fourth feature quantity output unit 80. In other words, the fourth feature quantity output unit 80 includes a neural network, a scaling unit, and a bias unit (all of which are omitted from the illustration). The fourth classification unit 88 outputs a classification result from the fourth feature quantity and the 4th classification weight in response to the fourth feature quantity from the fourth feature quantity output unit 80 as an input. The 4th classification weight of the fourth classification unit 88 may be a duplicate of the 2nd classification weight of the second classification unit 84 subjected to outer learning. In other words, the 4th classification weight is a condensed classification weight.

The learning unit 92d calculates a loss from the similarity between the classification result output from the second classification unit 84 and the classification result output from the fourth classification unit 88. Given that the second feature quantity output unit 76 is defined as a supervisor model and the fourth feature quantity output unit 80 as a student model, the learning unit 92d distills the fourth feature quantity output unit 80 so that the performance of the fourth feature quantity output unit 80, which is a student model, approaches the performance of the second feature quantity output unit 76, which is a supervisor model. The fourth feature quantity output unit 80 trained in this way becomes the feature quantity output unit 20 described above.

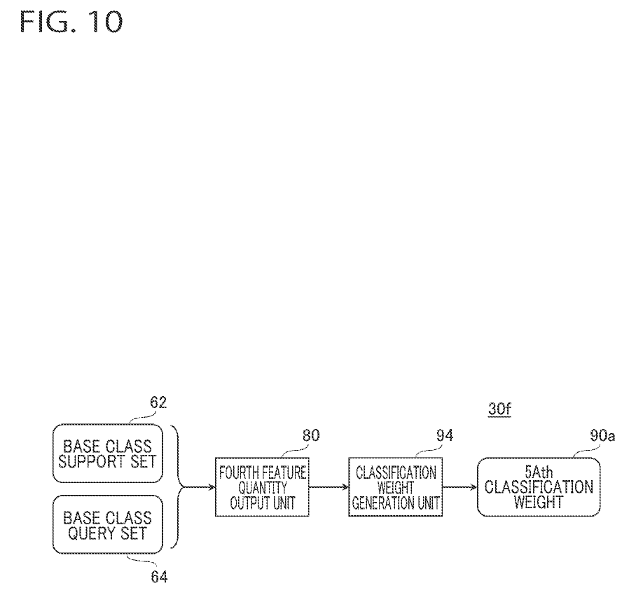

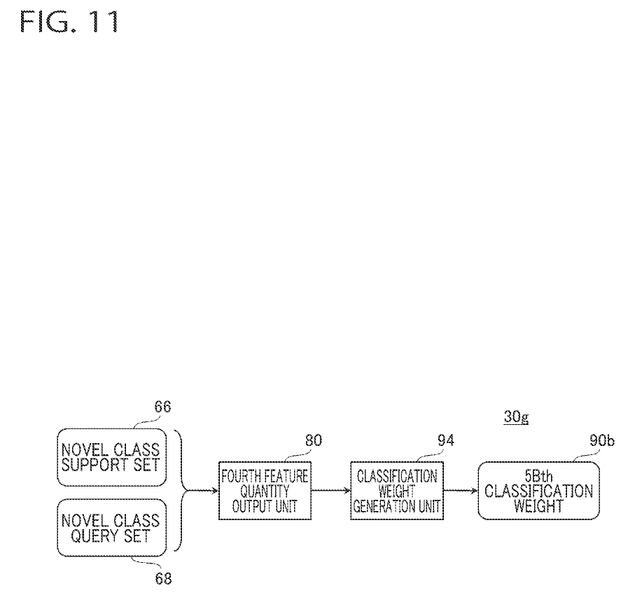

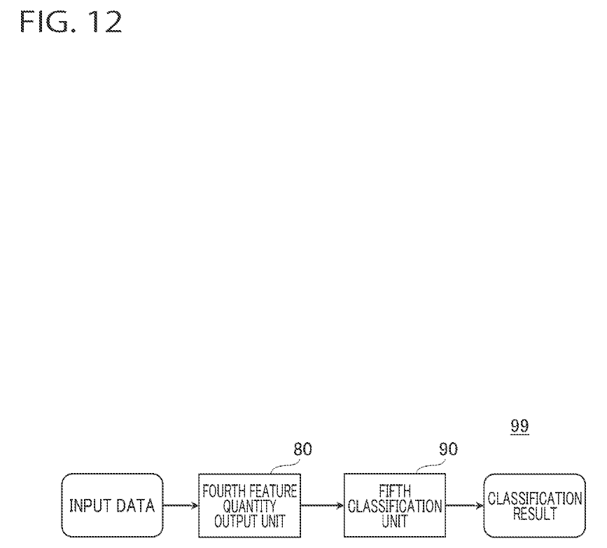

FIGS. 10 and 11 show an example of the configuration related to the process of step S18 of the flowchart shown in FIG. 2. As shown in FIGS. 10 and 11, learning apparatuses 30f, 30g generate the 5th classification weight of a fifth classification unit 90 (see FIG. 12) by using the fourth feature quantity output unit 80 generated by distillation in step S16 (S18). As shown in FIG. 10, the fourth feature quantity output unit 80 outputs the fourth feature quantity in response to the support set 62 and the query set 64 for the base class as inputs. A classification weight generation unit 94 averages the fourth feature quantity per each class and generates a 5Ath classification weight 90a of the fifth classification unit 90 in response to the fourth feature quantity from the fourth feature quantity output unit 80 as an input.

As shown in FIG. 11, the fourth feature quantity output unit 80 outputs the fourth feature quantity in response to the support set 66 and the query set 68 for the novel class as inputs. The classification weight generation unit 94 averages the fourth feature quantity per each class and generates a 5Bth classification weight 90b of the fifth classification unit 90 in response to the fourth feature from the fourth feature quantity output unit 80 as an input. FIG. 12 shows an example of the configuration of a classification apparatus 99 including the fourth feature quantity output unit 80 and the fifth classification unit 90. The fifth classification unit 90 retains the 5Ath classification weight 90a and the 5Bth classification weight 90b generated as described above as the 5th classification weight. The fifth classification unit 90 corresponds to the classification unit 40 in FIG. 1. Further, the fourth feature quantity output unit 80 corresponds to the feature quantity output unit 20 in FIG. 1.

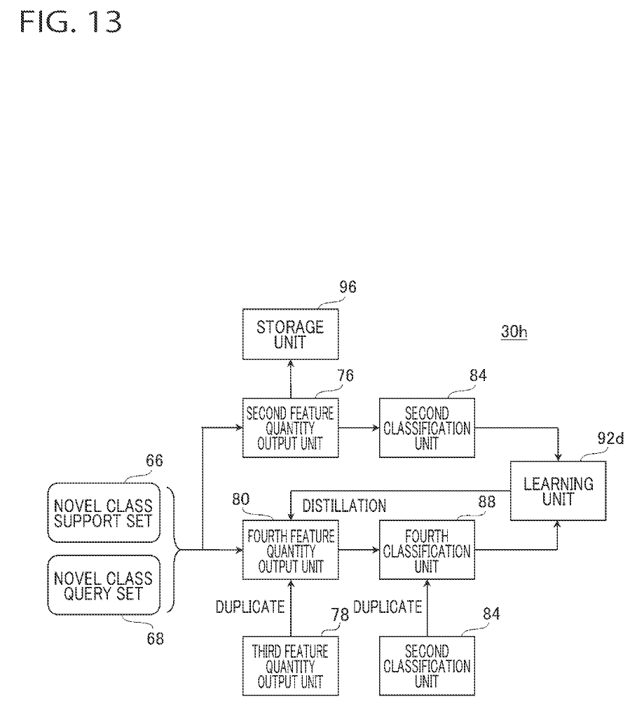

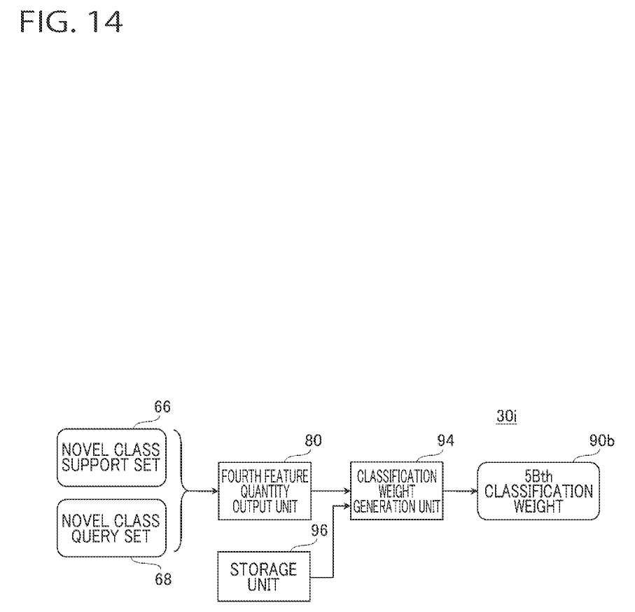

FIG. 13 shows a variation of the configuration related to the process of step S16. In the variation shown in FIG. 13, the learning apparatus 30h stores the second feature quantity output by the second feature quantity output unit 76 in a storage unit 96 in addition to executing the process of step S16 described with reference to FIG. 9. FIG. 14 shows a variation of the configuration related to the process of step S18. In the variation shown in FIG. 14, the classification weight generation unit 94 generates the 5Bth classification weight 90b by averaging the feature quantity per each class in response to the fourth feature quantity from the fourth feature quantity output unit 80 and the second feature quantity stored in the storage unit 96 as inputs, unlike the example described with reference to FIG. 11. In other words, the classification unit 40 will retain, as the classification weight, a feature quantity obtained by adding and averaging, per each class, the second feature quantity output by the second feature quantity output unit 76 in response to the novel class dataset as an input to the fourth feature quantity output by the fourth feature quantity output unit 80 in response to the base class data and the novel class data as inputs. Thereby, the classification apparatus 1 can retain the classification weight calculated by using, in addition to the feature quantity output by the feature quantity output unit 20, the feature quantity output by a further feature quantity output unit. Therefore, the accuracy of novel class classification can be improved even if the number of data items for the novel class is small.

As described above, the classification apparatus 1 according to the embodiment includes: the feature quantity output unit 20 that outputs a feature quantity of input data; and a classification unit 40 that retains, as a classification weight, a feature quantity obtained by averaging, per each class, the feature quantity output by the feature quantity output unit in response to a base class dataset and a novel class dataset with a smaller number of data items than the base class dataset and that outputs a result of classification of the input data by using the feature quantity of the input data and the classification weight. The feature quantity output unit 20 and the classification unit 40 are generated by running a plurality of learning sessions. In other words, the feature quantity output unit 20 and the classification unit 40 are generated by performing pre-training, meta learning, learning that includes removing or adding a path across nodes between adjacent layers in a neural network, and distillation.

Thereby, the classification apparatus 1 can obtain the feature quantity output unit 20 trained on the novel class by distillation, using information on the memory path obtained through base class learning. Therefore, the classification performance of the classification apparatus 1 on the novel class in continual learning can be improved even when the number of data items for the novel class is small.

Further, the classification unit 40 of the classification apparatus 1 according to the embodiment may retain, as the classification weight, a feature quantity obtained by adding and averaging, per each class, the feature quantity output by a further feature quantity output unit in response to the novel class dataset as an input and the feature quantity output by the feature quantity output unit 20 in response to the novel class data as an input.

Thereby, the classification apparatus 1 can retain the classification weight for the novel class calculated by using the feature quantity output by the further feature quantity output unit in addition to the feature quantity output by the feature quantity output unit 20. Therefore, the classification performance on the novel class can be improved even when the number of data items for the novel class is small.

In further accordance with the classification apparatus 1 according to the embodiment, the further feature quantity output unit may include a neural network trained by using a base class dataset and outputting a feature quantity of the input data, a scaling unit 72 that adjusts the value of the feature quantity output by the neural network by multiplying a multiplication value by the feature quantity, and a bias unit 74 that adds an addition value to the value adjusted by the scaling unit 72. The multiplication value and the addition value may be updated by inner learning that uses a support set for the base class. Inner learning may be performed by a learning apparatus including a further feature quantity output unit, a further classification unit (e.g., the second classification unit 84), and the learning unit 92. In inner learning, the neural network may output a feature quantity in response to the support set for the base class as an input, the scaling unit 72 may output a multiplication result obtained by multiplying the multiplication value by the feature quantity output, the bias unit 74 may output an addition result obtained by adding an addition value to the multiplication result output, the further classification unit may retain a condensed classification weight which is a weight for classification into each class and output a classification result from the addition result and the condensed classification weight in response to the addition result output as an input, and the learning unit 92 may calculate a loss in response to the classification result output as an input and update the multiplication value and the addition value based on the loss.

This allows the parameter used by the further feature quantity output unit to be learned by inner learning that uses the support set for the base class and so can improve the accuracy of classification.

In further accordance with the classification apparatus 1 according to the embodiment, the condensed classification weight may be updated by outer learning that uses a query set for the base class after the multiplication value and the addition value are updated. Outer learning may be performed by the learning apparatus 30. In outer learning, the neural network may output a feature quantity in response to the query set for the base class as an input, the scaling unit 72 may output a multiplication result obtained by multiplying the multiplication value by the feature quantity output, and the bias unit 74 may output an addition result obtained by adding an addition value to the multiplication result output, the further classification unit may retain a condensed classification weight which is a weight for classification into each class and output a classification result from the addition result and the condensed classification weight in response to the addition result output as an input, and the learning unit 92 may calculate a loss in response to the classification result output as an input and update the condensed classification value based on the loss.

Thereby, the condensed classification weight used by the further classification unit can be learned by outer learning that uses the query set for the base class so that the accuracy of classification can be improved.

The above-described various processes in the classification apparatus 1, etc. can of course be implemented by hardware-based apparatuses such as a CPU and a memory and can also be implemented by firmware stored in a ROM (read-only memory), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

What is claimed is:

1. A classification apparatus comprising:
a feature quantity output unit that outputs a feature quantity of input data; and
a classification unit that retains, as a classification weight, a feature quantity obtained by averaging, per each class, the feature quantity output by the feature quantity output unit in response to a base class dataset and a novel class dataset with a smaller number of data items than the base class dataset and that outputs a result of classification of the input data by using the feature quantity of the input data and the classification weight,
wherein the feature quantity output unit is generated by subjecting a neural network to training that uses the base class dataset, the training including removing or adding a path across nodes between adjacent layers in the neural network and then training the neural network by distillation by using the novel class dataset with reference to a further feature quantity output unit as a supervisor model.

2. The classification apparatus according claim 1,
wherein the classification unit retains, as the classification weight, a feature quantity obtained by adding and averaging, per each class, a feature quantity output by the further feature quantity output unit in response to the novel class dataset as an input to the feature quantity output by the feature quantity output unit in response to base class data and novel class data as inputs.

3. The classification apparatus according claim 1, wherein the further feature quantity output unit includes:
a neural network trained by using the base class dataset and outputting a feature quantity of the input data;
a scaling unit that adjusts a value of the feature quantity output by the neural network by multiplying a multiplication value by the feature quantity; and
a bias unit that adds an addition value to the value adjusted by the scaling unit,
wherein the multiplication value and the addition value are updated by inner learning that uses a support set for the base class,
wherein the inner learning is performed by a learning apparatus that includes the further feature quantity output unit, a further classification unit, and a learning unit,
wherein, in the inner learning,
the neural network outputs the feature quantity in response to the support set for the base class as an input,
the scaling unit outputs a multiplication result obtained by multiplying the multiplication value by the feature quantity output by the neural network,
the bias unit outputs an addition result obtained by adding the addition value to the multiplication result output by the scaling unit,
the further classification unit retains a condensed classification weight which is a weight for classification into each class and outputs a classification result from the addition result and the condensed classification weight in response to the addition result output by the bias unit as an input, and
the learning unit calculates a loss in response to the classification result output by the further classification unit as an input and updates the multiplication value and the addition value based on the loss.

4. The classification apparatus according claim 3,
wherein the condensed classification weight is updated by outer learning that uses a query set for the base class after the multiplication value and the addition value are updated, wherein the outer learning is performed by the learning apparatus,
wherein, in the outer learning,
the neural network outputs the feature quantity in response to the query set for the base class as an input,
the scaling unit outputs a multiplication result obtained by multiplying the multiplication value by the feature quantity output by the neural network,
the bias unit outputs an addition result obtained by adding the addition value to the multiplication result output by the neural network,
the further classification unit retains a condensed classification weight which is a weight for classification into each class and outputs a classification result from the addition result and the condensed classification weight in response to the addition result output by the bias unit as an input, and
the learning unit calculates a loss in response to the classification result output by the further classification unit as an input and updates the condensed classification weight based on the loss.

5. A classification method comprising:
outputting a feature quantity of input data; and
retaining, as a classification weight, a feature quantity obtained by averaging, per each class, the feature quantity output by the outputting in response to a base class dataset and a novel class dataset with a smaller number of data items than the base class dataset and outputting a result of classification of the input data by using the feature quantity of the input data and the classification weight,
wherein a feature quantity output unit executing the outputting is generated by being subject to training using the base class dataset, the training including removing or adding a path across nodes between adjacent layers in a neural network and then being trained by distillation by using the novel class dataset with reference to a further feature quantity output unit as a supervisor model.

6. A classification program comprising computer-implemented modules including:
a feature quantity output module that outputs a feature quantity of input data; and
a classification module that retains, as a classification weight, a feature quantity obtained by averaging, per each class, the feature quantity output by the feature quantity output module in response to a base class dataset and a novel class dataset with a smaller number of data items than the base class dataset and that outputs a result of classification of the input data by using the feature quantity of the input data and the classification weight,
wherein a feature quantity output unit executing the feature quantity output module is generated by being subject to training using the base class dataset, the training including removing or adding a path across nodes between adjacent layers in a neural network and then being trained by distillation by using the novel class dataset with reference to a further feature quantity output unit as a supervisor model.
